(19) United States
(12) Patent Application Publication
(10) Pub. No.: US 2016/0132676 A1
(43) Pub. Date: May 12, 2016

(54) SECURE PASSWORD STORAGE AND RECALL SYSTEM

(71) Applicant: Meir Avganim, Avganim (IL)

(72) Inventor: Meir Avganim, Avganim (IL)

(21) Appl. No.: 14/937,186

(22) Filed: Nov. 10, 2015

Related U.S. Application Data
(60) Provisional application No. 62/078,076, filed on Nov. 11, 2014.

(51) Int. Cl. G06F 21/45; G06F 21/62; G06F 21/32

(52) U.S. Cl. CPC G06F 21/45; G06F 21/32; G06F 21/62

(57) ABSTRACT

A method and system for securely storing passwords and recalling any of the stored passwords in the computer using a single, master password. The system provides password handling software that is configured to enable a user to store in and retrieve from the computer the passwords via user interface. Whenever the password handling software is utilized, a facility in the software turns off communication hardware through which the computer ordinarily communicates with other computers over public communication lines, in order to prevent snooping or eavesdropping on the user's communications during password storage and retrieval sessions.

### CROSS-REFERENCE TO RELATED APPLICATIONS

This application claims benefit of and priority to U.S. Provisional Application Ser. No. 62/078,076 filed Nov. 11, 2014, the contents of which are incorporated herein by reference

### BACKGROUND OF THE INVENTION

The present invention relates generally to information systems and, more particularly, to a uniquely configured system and method for managing access to a plurality of passwords as may be used to restrict access to a variety of systems. Advantageously, the present invention provides a method for creating, storing, accessing, retrieving and displaying a plurality of records wherein the records may include an account identification, a user ID and a password associated with the account identification and the user ID and wherein account identifications, user IDs and passwords are accessible by use of a single master passcode.

User IDs and passwords are commonly used tools for protecting access to restricted data. Such data may include the personal information of an individual such as financial account information or medical history information. As is well known, such information is typically stored in various systems such as on websites and in various computer systems. Passwords provide a common means for user authentication prior to allowing access to systems and accounts in order to prevent misuse of such information.

For example, identity theft is a growing problem and is due in large part to the ever increasing amounts of information that are now stored in various internet-accessible accounts. Common forms of identity theft include the unauthorized access and misuse of credit card information in order to obtain goods and services by someone impersonating the account holder. Passwords are commonly used to guard against unauthorized access to information. Such information can include website names and/or addresses and associated account information, bank account numbers, credit card information such as credit card numbers, three and four digit security codes for credit cards, stock brokerage account numbers, insurance policy numbers.

Other information that may be subject to unauthorized access may include computer or application names and associated files and information, passport and drivers license numbers, alarm codes, membership program information such as airline frequent flyer program account numbers, hotel and car rental loyalty numbers, bank PIN codes, and web domain and hosting account access information. It is also sometimes desirable to have quick and easy access to certain types of information such as alarm company telephone numbers, expiration dates for driver's license and passport numbers as well as customer service telephone numbers.

As the majority of sensitive information is increasingly stored in computer systems, many individuals have multiple accounts requiring user IDs and passwords which correspond to each account. Ideally, a different password is used with a different account in order to help avoid the above-mentioned problem of unauthorized access to the account should an unauthorized person discover the particular user ID and password for a single account. The large number of user IDs and corresponding passwords increases complexity and presents problems associated with convenience and security of the accounts.

As a result, many users develop a tendency to use simple passwords or even the same password for different accounts. In this manner, instead of memorizing a plurality of different passwords corresponding to different user IDs, it is only necessary to memorize a single or a few passwords. Unfortunately, the practice of utilizing an easy-to-guess password or the same password for different accounts may compromise the security of any one of the accounts should an unauthorized person discover the identity of a password.

In an attempt to avoid the security risks with using the same password for different accounts, some users may use different passwords for different accounts but may generate hand written notes, sometimes on a single piece of paper, listing each user ID and password associated with an account. Unfortunately, such practice poses a risk that the paper may become lost or misplaced and/or found by and/or stolen by someone who may misuse the information. Alternatively, some users generate a computer record of accounts, user IDs and/or passwords and may attempt to hide the information by storing it in a hidden or misdescriptive folder or file. This poses a risk that someone with unauthorized access to the computer, such as a hacker, may easily get at such information through the use of increasingly sophisticated prying and password-guessing technology.

Complicating the problem, some online accounts require that users change their passwords on a periodic basis such as on a monthly basis which forces the user to come up with even more passwords if they want to use unique passwords for all their accounts, thus exacerbating the problem of managing and remembering all those passwords. For diligent individuals, the use of hard-to-guess passwords often results in the user being unable to recall the complex password and then wasting time trying to remember or try passwords, or requiring that the user request a password reminder or reset during which time the user may be unable to access their accounts.

As can be seen, there exists a need in the art for a system and method for storing multiple records of different passwords for different accounts. More particularly, there exists a need in the art for a system and method for storing a plurality of records such as an account identification along with corresponding login or authentication information such as a user ID and password. In addition, there exists a need in the art for a system and method for storing a plurality of records wherein the records are conveniently stored and accessible in a single location and which allows for the use of hard-to-guess or complex passwords thereby minimizing the risk that information may be accessed by an unauthorized user.

Although certain systems and algorithms have been disclosed to ameliorate and solve the aforementioned difficulties and requirements as described, for example, in the United States patent publication 2009/0328198, it remains so that existing solutions remain vulnerable to hackers installing on users' computers, tablets, and/or telephones, trojan horse programs that snoop and report to the hackers confidential information as it is being entered into the database or recalled therefrom.

The contents of the aforementioned U.S. Patent Publication No. 2009/0328198 and the contents of U.S. Patent Publication No. 2008/0147967 are incorporated by reference herein.

### SUMMARY OF THE INVENTION

It is an object of the present invention to provide a system that avoids the drawbacks of the prior art.

It is another object of the invention to provide a system that insulates the system of creating, storing and recalling passwords from snooping by disconnecting the computer or tablet or mobile telephone from the Internet and/or from any external devices during utilization of the software used for creating, storing and recalling passwords.

The foregoing and other objects of the invention are realized in the system according to the invention which preferably comprises a method for securely storing passwords and recalling any of the stored passwords using a master password. The method steps comprise: providing a computer in which a system for storing and recalling passwords is provided via previously loaded software; enabling a user to access the prestored software and to operate the software to recall one or more previously stored passwords by inputting a single master password into the computer software; and wherein said aforementioned steps are performed by causing the software to issue instructions, to turn off hardware involved in the ability of the computer to communicate outside of the computer boundaries, shutting off Internet and like communications while the system looks up and provides passwords to a user.

Other features and advantages of the present invention will become apparent from the following description of the invention which refers to the accompanying drawings.

### BRIEF DESCRIPTION OF THE DRAWINGS

FIG. 1 is a prior art, conventional block diagram of a computer system, having an architecture usable with the present invention.

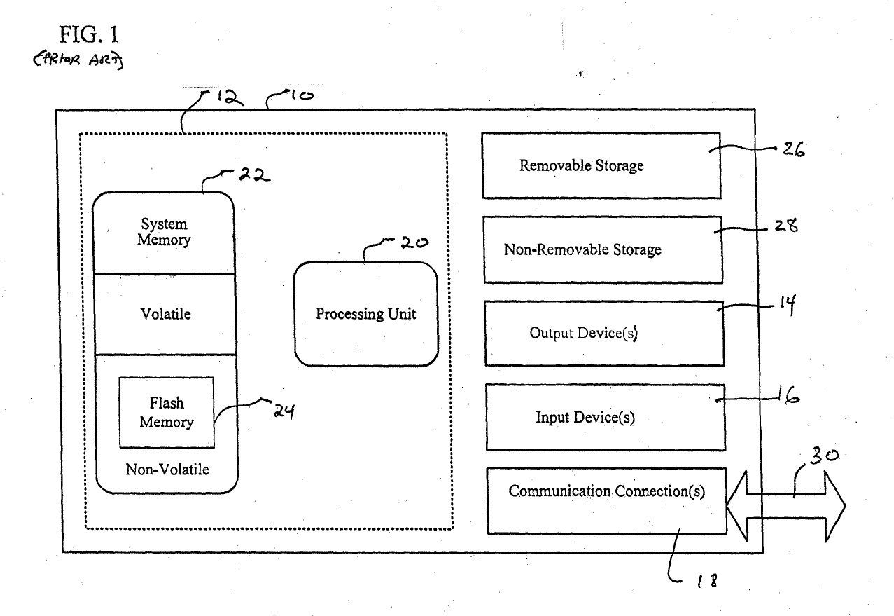

FIG. 2 is a flowchart of a setup program in accordance with the present invention.

FIG. 3 is a program usage protocol flowchart in accordance with the present invention.

FIG. 4 is a password programming module in accordance with the present invention.

### DETAILED DESCRIPTION OF EMBODIMENTS OF THE INVENTION

Referring to the drawings, the overall computer, tablet, mobile telephone or any other communication device (not shown) in accordance with the present invention is internally provided with a controller/processor and communication hardware 10, which includes a processor 12, removable storage 26, non-removable storage 28, and output devices 14, comprising, for example, a printer, a display, a speaker system and the like. The accessories/peripherals may also include input devices 16 which may comprise a keyboard, a camera, a microphone and the like. Lastly, the peripherals also include communication connection hardware 18, communicating over a bus 30 and providing access through communication hardware channels 30 which may comprise landline telephone lines and wireless communications, through which one may communicate to other devices through the Internet or internal communication paths and the like, all as well known in the art.

Within the processor 12, the central unit for executing all of the algorithms is the processing unit 20 which operates with its own internal memory 22, which may include system memory, volatile memory, flash memory 24 and other non-volatile memory, such as RAM and the like. As is well known to all skilled in the art, software modules enable the processing unit 20 to execute various specific algorithms defined further on, to obtain specific functionality and to provide the unique physical outputs that are described and elaborated further on, in order to achieve the solutions provided by the present invention.

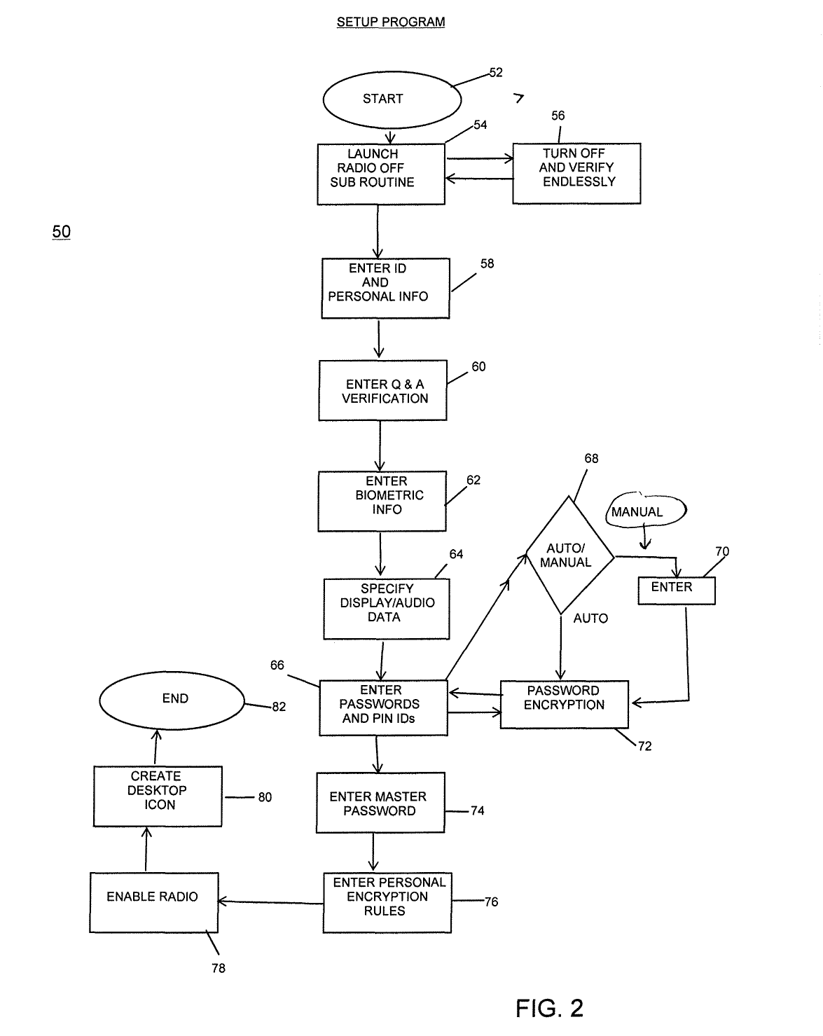

Referring to FIG. 2, the setup program 50 comprises several software modules stored within the memory of the processor 12 (or optionally external thereto) which executes an algorithm which commences with a start box 52 and launches itself either upon being loaded by operator commands or pressing of an icon. The algorithm starts by turning off the radio or landline communications hardware 18/30 at box 54, to avoid any external snooping or listening or eavesdropping on the setup program 50. To this end, at the box 56 is executed a continuous subroutine which keeps instructing the communication hardware 18 to turn off. The software continually verifies that this has been done, to avoid an external device or trojan horse software that has been embedded within the computing device from turning on the radio communication.

Thereafter, the user is prompted to enter his/her personal identification information at 58, to provide all kinds of information intended to be used for authentication and verification purposes as explained below. In the same vein, question and answer verification is entered in box 60, this information comprises posing to the user questions and to choose and provide answers to these favorite questions. For example, the year the user graduated from high school; the place of their birth; and the like. At module 62, the user is prompted to enter biometric information, and this can comprise allowing the processor's camera (not shown) to take a picture of the user or of a photo of the user, and/or a fingerprint, or to store a voice sample of the user.

At box 64, the user specifies whether the password information will be provided through the display of the processor or possibly through a speaker.

Continuing with the program setup, box 66 requests the user to enter the names of institutions for which passwords are to be stored, as well as the corresponding passwords. This process can involve either an automatic software that chooses the password, or a manual data entry. Thus, at decisional box 68, the user is asked to indicate whether the preference is to automatically generate the passwords. If yes, the process proceeds to software module 72, where the passwords are generated, and then stored in encrypted form. If the password selection is to be manual, the process continues to software module 70, where the information is manually entered and thereafter encrypted at software module 72.

Once all of the passwords have been entered and the information recorded and encrypted, the program proceeds to software module 74 where the user is asked to input his preferred master password. If should be noted that this master password might be limited to the selection of a combination of both letter characters and numerics and be of a minimum size, e.g., more than six characters.

In addition, the user can provide at software module 76 her/his personal encryption rules for both the entry of data via the setup software, as well as during the software display of the passwords. For example, a user may specify that when passwords are displayed, the third letter character in the password is always to be a character which is two letters higher in the alphabet. Similarly, for numerics, the user can specify that the second numeric character is really the number that is obtained by either adding or subtracting “4” to that numeric. Thus, when a user enters the password “ABC123”, the software might actually interpret that as standing for the master password “ABE127”. As a result, even if a snooping software would report the keyboard strokes to a remote hacker location, the hacker would still be in the dark as to the actual characters that comprise the master password, because they would not be privy to the personal encryption rule that the user had created during the initial program setup.

Once the software has been set up, the radio communication is re-enabled at software module 78, and simultaneously the desktop icon is created at 80, which enables subsequently the user clicking on that desktop icon whenever the user wants information about any particular password that he/she may need in order to enter it for communicating with a given institution which may a bank, a retail store, and the like. The program ends at 82.

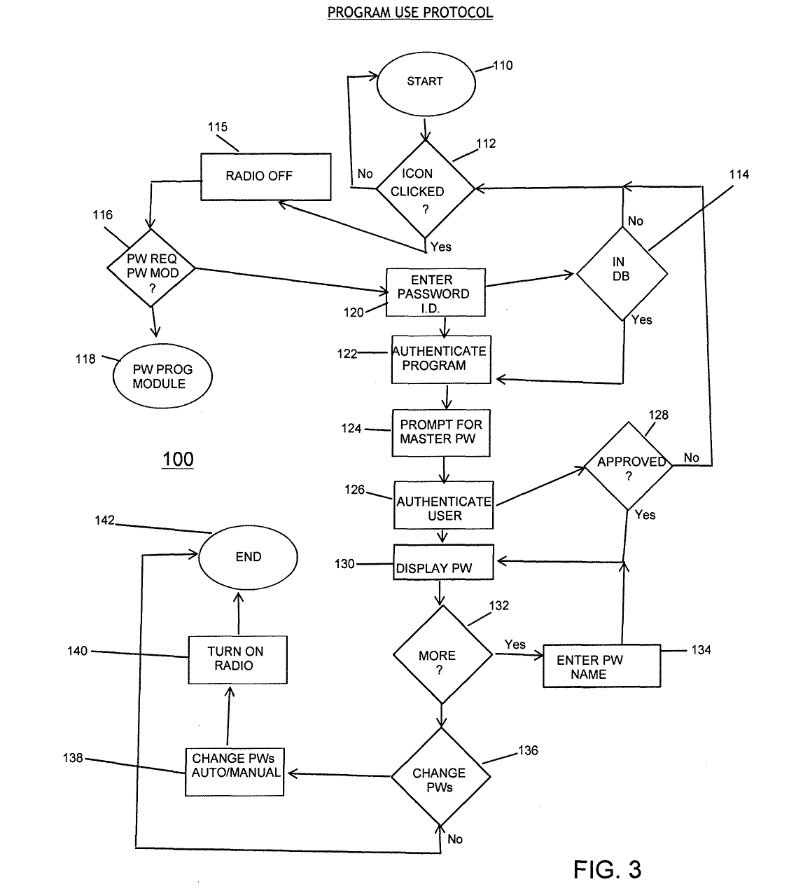

Reference is now made to FIG. 3, for a description of the use of the computer program, system and facility of the present invention. The use program 100 is launched at module 110 and proceeds to decisional box 112 to determine whether a user has clicked the user icon. If no, the program waits for such a click to occur. If yes, the program first turns off communications with the world outside the given computer and then proceeds to software module 116. Here the decision software queries whether the applicant wishes to modify/alter any particular password. If the user desires to modify a password, the program proceeds to software module 118 which redirects the program to the password programming modules previously described with reference to FIG. 2.

Otherwise, the program proceeds to software module 120, which requests and displays information to prompt the user to identify the institution or facility for which a password is requested, e.g., Chase Bank or Amazon or Ebay or the like. In decisional box 114 the program determines whether the requested password is in the database. If not, the program ignores the request, issuing a display such as “not valid entry”. The user then needs to re-click the icon at 112.

Otherwise the program proceeds to 122, which is intended to provide the level of comfort to the user that the program running on his phone has not been hijacked by another piece of software and is masquerading as the software organizer of the present invention. To this end, the actual software displays on the system either the photo that has been previously inserted by the user, so the user sees him/herself and knows that the real program, and not a rogue software, is communicating with the user. Another alternative is to play the voice of the user or to show a unique photo; for example, of a horse or a bird or the like. If the user does not see the correct information, the user is alerted not to proceed.

Otherwise the software prompts the user to enter the master password at 124. Upon the entry of the master password (which is entered “incorrectly” in accordance with the personal conversion rule set up by the user, if desired), the program proceeds to 126 to authenticate the user by prompting the user to either speak a sentence or by taking a photo of the user and comparing it to the internally stored biometric information. Hence, a stranger who got a hold of the Master Password would still be unable to receive the individual passwords.

Once the user has been “authenticated” at 128, the program proceeds to display, for a short duration, the requested password 130 and prompts the user to either speak a word or to touch a screen icon at 132, whether the user wants to see another password. If so, the program proceeds to 134 and provides the second password, and so on. Note, each password is displayed for a short duration only, in a manner which does not allow a snooping software (even if it has been somehow loaded on the user's computer) to actually copy or perceive the password.

Thereafter, the program proceeds to decisional box 136 and asks whether any of the passwords are to be changed and, if yes, the program proceeds to 138 to change the passwords in either an auto or manual fashion, as previously described. The program ends this procedure by turning on the radio communication (which has previously been turned off) at software module 115 in a manner similar to the previous description given relative to software modules 54 and 56. The program concludes at 142.

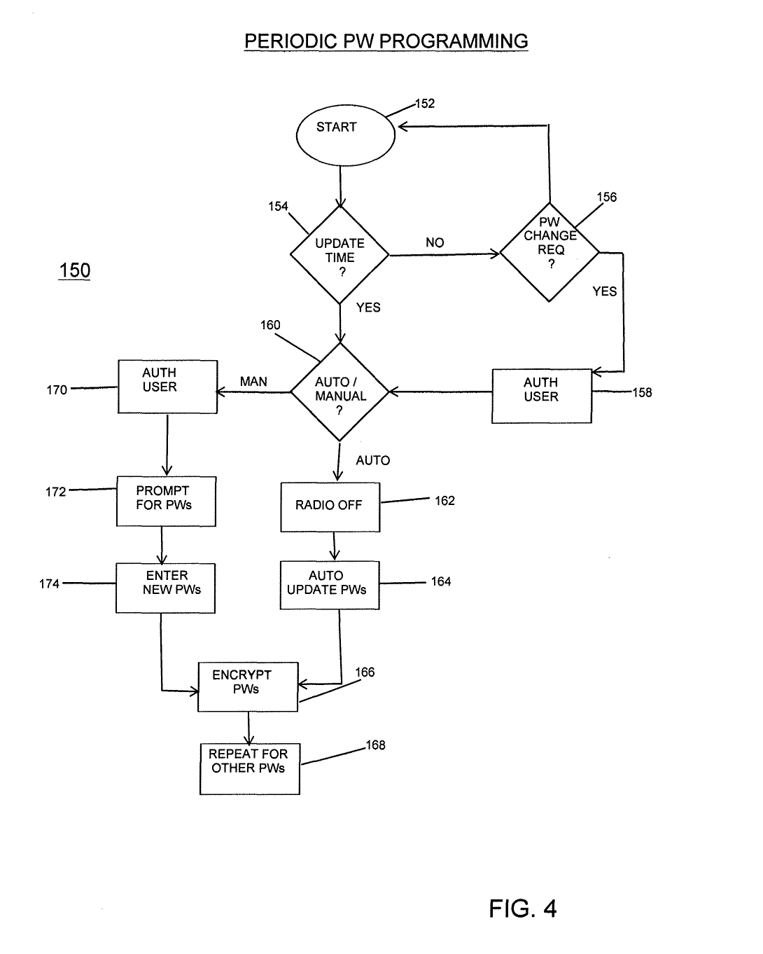

In accordance with other aspects of the invention, the internally stored passwords can be periodically, automatically updated as described below by reference to FIG. 4. For example, if the software has been preprogrammed to update/alter passwords every four months, then the operating program 150 begins with the start module 152 and thereafter proceeds to decisional box 154 querying whether it is presently the update time. If no, the software module 156 checks whether an operator has touched a given icon of the program and has, nonetheless, just requested to change a password and, if so, it “authenticates” the user as previously described at 158 and proceeds to decisional box 160. In decisional box 160, the program determines whether the software has been preset for automatic password changing or only manual. If automatic, the program turns the communication modem off at 162 and then changes all of the passwords at 164, and then encrypts and stores those modified softwares at 166. The process is repeated for all of the passwords at 168.

If, on the other hand, the user preset the program for only manual reprogramming, the user is authenticated as previously described at 170 and thereafter prompted for the new password at 172, which new passwords are entered and stored at 174 and thereafter encrypted at 166. As before, the process can be repeated for other passwords at 168.

In accordance with the foregoing description of the invention, one of ordinary skill in the art would appreciate that while a user sets up the program, or requests a certain password to be displayed, the radio or modem communication of the computer is totally shut off repeatedly, not allowing anyone to snoop on the software, as it is running, nor allowing a snooping software that has been somehow loaded on the user's computing device to report the keystrokes or other information to a remote location.

Such a snooping rogue software is also prevented from storing the keystrokes or the display information in a local memory for later transmission to another computer, because the protected information is not displayed or entered in its precise format and any attempt to interfere with the authentic program would be noted by the user. For example, if the passwords are communicated by voice, the trojan software would not be able at all to know what the password is, as software cannot “hear”. The user, on the other hand, can immediately either be reminded of the particular password and he/she may jot it down in whole or in part, and immediately thereafter use it for whatever purpose they need to.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method for securely storing passwords and recalling any of the stored passwords using a master password, the method comprising:
providing a computer including password handling software configured to enable a user to store in and retrieve from said computer said passwords via a user interface, said computer further including communication hardware configured to enable the computer to communicate with other computers over public communications lines;
operating the password handling software to retrieve one or more of said passwords by inputting into the computer a single, master password; and
turning off said communication hardware while a user is engaged in active utilization of said password handling software via said user interface.

2. The method of claim 1, wherein the password handling software is configured to store biometric information of at least one authorized user.

3. The method of claim 1, wherein the method includes authenticating a user based on previously stored biometric information associated with the user.

4. The method of claim 1, wherein the method includes authenticating the software to the user by displaying or playing to the user at least one of alpha-numeric information, visual information and/or vocal information recognizable by the user.

5. The method of claim 1, wherein said user interface comprises a microphone in the computer and including inputting said passwords via said microphone.

6. The method of claim 1, including encrypting said passwords and storing only encrypted passwords in said computer.

7. The method of claim 1, including storing and displaying said passwords based on personal encryption rules entered by the user.

8. The method of claim 1, including entering passwords via touch screen communications.

9. The method of claim 1, including displaying to a user information unique to that user that has been previously selected by the user to be displayed to the user when communicating with the password handling software.

10. The method of claim 1, including authenticating a user by requiring a user to enter a password that is unique to that user, which serves only for the purpose of initiating operation of the password handling software.

11. A system for securely storing passwords and recalling any of the stored passwords using a master password, the system comprising:
a computer including password handling software configured to enable a user to store in and retrieve from said computer said password via a user interface;
communication hardware and software configured to enable the computer to communicate with other computers over public communication lines;
the password handling software comprising a facility that enables retrieving one or more of said passwords by inputting into the computer a single, master password; and
a software facility for turning off said communication hardware while a user is engaged in active utilization of said password handling software.

12. The system of claim 11, wherein the password handling software is configured to store biometric information of at least one authorized user.

13. The system of claim 11, wherein the system includes authenticating software for authenticating a user based on previously stored biometric information associated with the user.

14. The system of claim 11, including software for authenticating the software handling software to the user by displaying or playing to the user at least one of alpha-numeric information, visual information and/or vocal information recognizable by the user.

15. The system of claim 11, wherein the user interface comprises a microphone in the computer.

16. The system of claim 11, including a facility for encrypting said software and storing only equipment passwords in said computer.

17. The system of claim 11, including a software facility as configured to store and display said passwords based on personal encryption rules selected by and entered into the computer by the user.

18. The system of claim 11, including authenticating software configured to authenticate a user by requiring the user to enter a password that is unique to that user, said authenticating software being configured and serving only for the purpose of initiating operation of the password handling software.
